(19) United States
(12) Patent Application Publication
(10) Pub. No.: US 2016/0229533 A1
(43) Pub. Date: Aug. 11, 2016

(54) Efficient Flight Paths for Aerial Corridor Inspection

(71) Applicant: Izak Jan van Cruyningen, Saratoga, CA (US)

(72) Inventor: Izak Jan van Cruyningen, Saratoga, CA (US)

(21) Appl. No.: 14/616,107

(22) Filed: Feb. 6, 2015

(51) Int. Cl. B64C 31/024; B64C 39/02; G08G 5/00; B64D 47/08

(52) U.S. Cl. CPC B64C 31/024; B64D 47/08; B64C 39/024; G08G 5/0069; G08G 5/0034; G08G 5/0086; B64C 2201/021; B64C 2201/127; B64C 2201/162

(57) ABSTRACT

FIG. 1 shows an efficient flight path for airframe 10 with camera 16 flying along a transmission line utility corridor containing towers 40, 42, and 44. Between the towers the airframe is in a fast linear glide 18 to check the right of way for encroachment. Abreast of tower 42, the airframe spirals down 20 with power plant 11 off to take more detailed pictures. When the tower inspection is complete, power plant 11 is turned on to start a power climb 22 back up to prepare for glide 24 to the next tower 44, where the airframe again spirals down 26 for a closer inspection. On the return flight, a close-in conductor inspection is flown in catenary arcs with glides 28, 32 on the downslope and power climb 30, 34 on the upslope.

### CROSS-REFERENCE TO RELATED APPLICATIONS

This application claims the benefit of provisional patent application Ser. No. 61/937,048 filed 2014 Feb. 7 by the present inventor.

### BACKGROUND—PRIOR ART

Fuel is a major expense for most aircraft, so there has been a great deal of effort expended in developing energy efficient flight plans. A power plant large enough for take-off and climbing flight, is two to four times larger than needed for level flight. Most engines run much less efficiently when operated at a fraction of their maximum power. Transmissions are used to correct this mismatch in terrestrial vehicles.

Soaring gliders provide the best energy efficiency for experienced pilots since they use energy in thermals to stay aloft. Touring motor gliders provide energy efficient cross-country flight without reliance on thermals. However, they must plan for a landing site just in case the engine does not restart. They have a minimum safe height above ground.

Unmanned aerial vehicles (UAV) are an excellent vehicle for close-in inspection of utility corridors. They do not require the same safety margin as manned flight, so they can be flown at much lower heights above ground. Regulatory agencies limit their weight, speed, and/or the height above ground under which they may be used. For example, in the United States they must currently stay under 400 feet above ground level. New regulations are forthcoming, but if prior regulations are a guide, then there will be different requirements based on total weight and speed. Previous regulations had breakpoints at 2, 9, and 25 kg. In the UK a 20 kg airframe flown below 400 feet operates under BNUC, but a higher flight or larger vehicle is treated as a manned airframe. In Germany a 5 kg UAV may be flown up to 300 m. A light UAV has fewer regulatory constraints. In a UAV with an electric power plant, the battery is a large fraction of the weight of the airframe. Efficient flight reduces the energy required to complete the mission and thus the battery weight.

Utility and transportation corridors are long linear rights of way with occasional point features or points of interest that have to be inspected in detail. For example overhead electrical lines include transmission, distribution, telephone, cable TV, and electric railway lines plus the towers to support these lines. They need the right of way inspected for vegetation incursions; and the towers inspected for damage and deterioration. Oil, gas, and water lines need the right of way inspected for incursions or leaks; and the pumping stations and valves inspected in much greater detail. Transportation corridors include roads, railways, and canals. They need a general inspection of the road, rail, and canal right of way with much more detailed inspection of bridges, signs, signals, and locks.

### SUMMARY

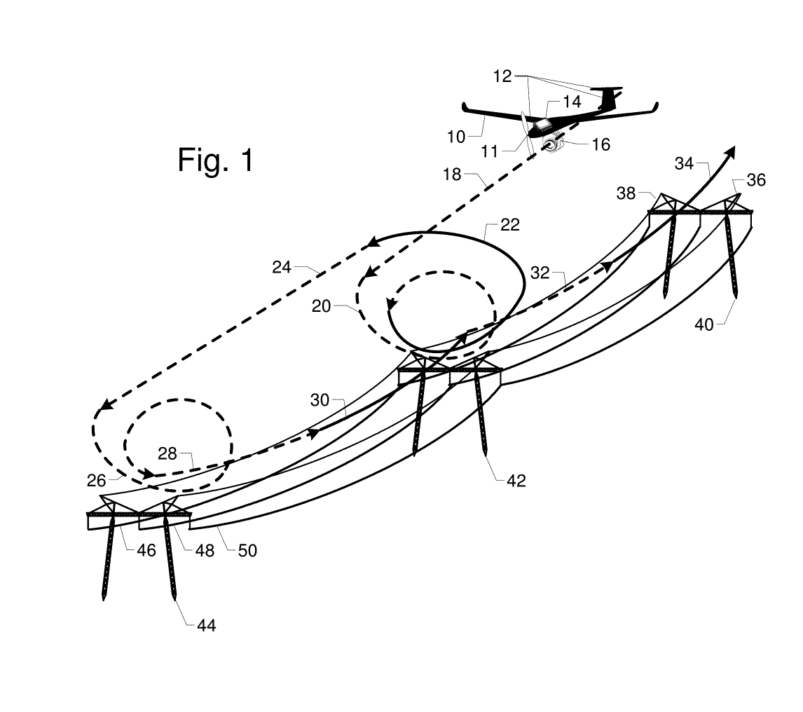

FIG. 1 shows an efficient flight path for airframe 10 with camera 16 flying along a transmission line utility corridor containing towers 40, 42, and 44. Between the towers the airframe is in a fast linear glide 18 to check the right of way for encroachment. Abreast of tower 42, the airframe spirals down 20 with power plant 11 off to take more detailed pictures. When the tower inspection is complete, power plant 11 is turned on to start a power climb 22 back up to prepare for glide 24 to the next tower 44, where the airframe again spirals down 26 for a closer inspection. On the return flight, a close-in conductor inspection is flown in catenary arcs with glides 28, 32 on the downslope and power climb 30, 34 on the upslope.

### ADVANTAGES

Although energy efficient flight paths are well known in the prior art, various aspects of the embodiments of my corridor inspection flight path are advantageous because:

The power plant is run at optimal efficiency for the climbing segments,

The power plant consumes no energy during the gliding segments.

The power plant and fuel or battery can be sized correctly for the mission thereby minimizing airframe weight,

Further unexpected advantages include:

When the power plant is off, the vibrations in the airframe are much less, eliminating one source of blur in the photographic exposures,

The arcs around the towers reduce blur due to forward motion,

The drift in the inertial measurement unit can be reset in the loops around the towers,

Excessive corona discharge, possibly indicating insulator failure at a tower, is much easier to detect with microphones (audible and ultrasound) and radio frequency meters when the power plant is off,

Altitudes measured on the outbound right of way inspection can be used for precision flying during the return detailed inspection.

Other advantages of one or more aspects will be apparent from a consideration of the drawings and ensuing description.

### FIGURES

1. Perspective view of utility corridor inspection flight path for transmission lines.

2. Cross-path section of utility corridor inspection flight path for transmission lines.

3. Perspective view of transport corridor inspection flight path for highway.

4. Cross-path section of transport corridor inspection flight path for highway.

5. Flight planning flowchart for determining flight parameters.

6. Autopilot flowchart for flying an efficient corridor inspection.

### DETAILED DESCRIPTION

This section describes several embodiments of the efficient corridor inspection flight path with reference to FIGS. 1-6.

FIG. 1 is a perspective view of a utility corridor inspection flight path for power transmission lines. An aerial inspection system includes an airframe 10 that supports power plant 11, control surfaces 12, autopilot 14, and camera 16. Towers 40, 42, and 44 support phase conductors 46, 48, and 50, as well as shield wires 36 and 38. Airframe 10 inspects the corridor in a flight path combining linear right of way glide 18; followed by spiral tower glide 20 around tower 42; power climb 22; linear right of way glide 24; and spiral tower glide 26 around tower 44. On the return path airframe 10 does a close-in conductor inspection by flying catenary glides 28, 32 on the downslopes and catenary climb 30, 34 on the upslopes.

This example is for a single circuit 500 kV transmission line where towers 40, 42, and 44 are ˜40 m high, ˜25 m wide, and spaced 200-600 m apart. Phase conductors 46, 48, and 50 are aluminum strands over a steel core with a total diameter of 3-6 cm. Shield wire 36 and 38 are 1-2 cm in diameter.

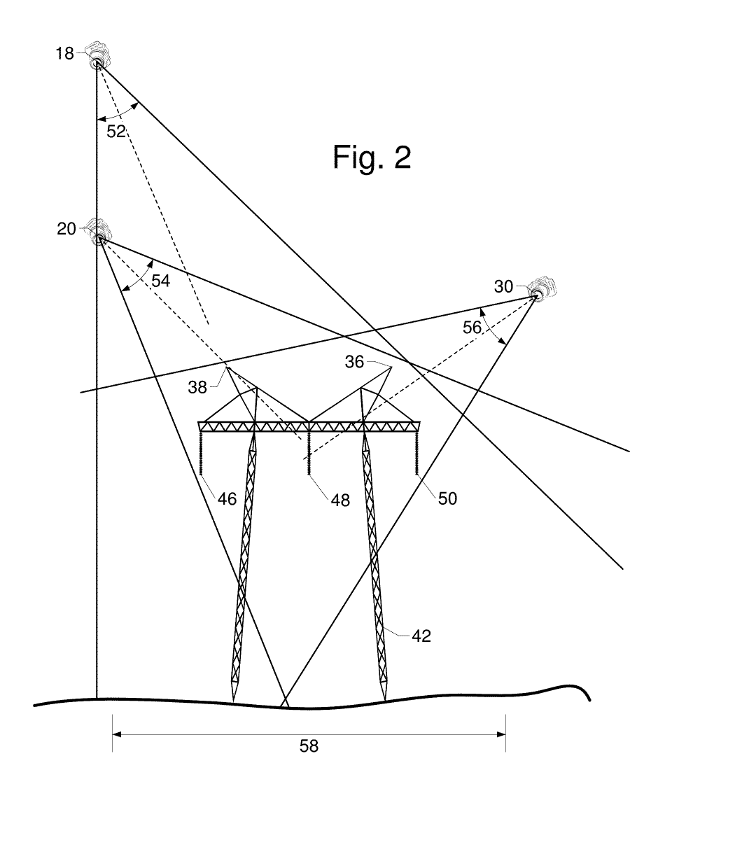

FIG. 2 is a cross-path section of the corridor inspection flight path of FIG. 1 at tower 42. For linear right of way glide 18, the angle of view 52 encompasses the entire right of way 58 and tower 42. Spiral tower glide 20 is flown lower and closer with angle of view 54 including the top of the tower that is least visible from the ground. Transmission towers are usually wider across the right of way than along the right of way so the spiral is modified with a more elliptic or oval shape. Conductor inspection with catenary climb 30 is flown closer still with angle of view 56 just encompassing all the wires. Single circuit transmission lines often have three phase conductors in a horizontal plane with the shield wires above them, so the conductor inspection 30 is flown low as shown. Transmission lines with two circuits are often more vertical with the phase conductors grouped (2, 2, and 2), so then conductor inspection with catenary climb 30 is flown with angle of view in a more vertical orientation. Ideally the right of way and all the objects of interest are inspected in one flight with the best possible resolution.

Transmission line inspection involves three different mission profiles, each with angle of view and resolution tradeoffs. These will be illustrated in the following paragraphs with a sample camera that has a full-frame sensor (24×36 mm), 5 micron pixel spacing, and a 28 mm focal length lens.

It is desirable to capture the entire field of interest in one flight, rather than repeatedly flying the corridor. It is also desirable to use a fixed focal length lens since zoom lenses have changing interior orientations that make them difficult to calibrate for photogrammetry. Fixed prime lenses generally have better optical characteristics than zoom lenses of equivalent focal lengths. A wide angle lens with a 24 to 28 mm focal length (35 mm equivalent) provides a wide angle of view without excessive distortion and aberration. For transmission line inspection, cameras are usually oriented with the long sensor dimension along the flight path. This allows faster flight speeds for a given image overlap and the camera framing rate.

The angle of view for a given lens and sensor combination equals two times the arctangent of half the sensor dimension divided by the focal length

AOV=2*atan(sensor dimension/(2*focal length))

For a full-frame sensor aligned with the flight path (24 mm dimension across the path) with a 28 mm focal length lens, the angle of view is 46 degrees, as shown in FIG. 2. A 24 mm focal length lens would have a 53 degree angle of view for the same sensor. The field of view requirement sets the minimum distance from camera 16 to the object of interest.

The resolution in aerial photography is estimated by the ground sample distance (GSD). The GSD is the separation between camera pixels as projected on the ground. The GSD equals the object distance (flying height above ground here) times the pixel separation divided by the lens focal length. So for 5 micron pixels and a lens focal length of 28 mm, at a flying height of 400 feet (˜120 m), the GSD˜2.1 cm. The sample distance requirement sets the maximum distance from camera 16 to the object of interest.

The first type of mission in transmission line inspection is checking the right of way for vegetation incursion, man-made incursions, and wire clearances. A ground sample distance (GSD) of about 5 cm and an angle of view (AOV) encompassing the entire right of way 58 would allow these checks. For a 28 mm equivalent lens, a flying height of about 75 m as shown in angle of view 52 in FIG. 2 would cover right of way 58 at a GSD of 1.3 cm. Flying higher gives a wider field of view and a larger GSD.

If towers 40 and 42 are 500 m apart and airframe 10 has a 20:1 glide ratio, then starting with a flying height of 75+25=100 m at tower 40 allows linear right of way glide 18 to be done with power plant 11 off. At the start of linear right of way glide 18, the field of view is larger than required, but the GSD˜1.8 cm is still fine enough to meet the mission objectives. By turning power plant 11 off, linear right of way glide 18 does not consume energy and it reduces vibration in airframe 10, thereby allowing much sharper images.

For transmission lines in hilly terrain, the towers may be at different altitudes. If tower 42 is uphill from tower 40, then the start of linear glide 18 at tower 40 will need to be higher. If the required start is so high the GSD distance gets too big, then the end of linear flight path 18 may need an additional power climb.

A second type of mission in transmission line inspection is checking towers for insulator damage (gun shots and contamination), bird nests, tripped surge arrestors, loose nuts, corrosion, etc. These can be detected with a sample distance at the tower of about ½ cm. At the 74 m flying height at the end of linear right of way glide 18, the object distance to the center conductor 48 is about 55 m to give a tower sample distance of about 1 cm. To get a smaller tower sample distance, airframe 10 enters spiral tower glide 20, again with power plant 11 off. This spiral provides higher resolution inspection images from all angles around the tower and still does not use any energy for flight.

Several more advantages accrue from turning power plant 11 off for tower inspection. First, it is much more effective to use audible and ultrasound microphones to detect corona and partial discharge. Partial discharge can be a predictor of insulator failure. Second, radio and television frequency interference is much easier to detect. Thirdly, vibration from power plant 11 is stopped, reducing blur due to camera shaking. Finally flying an arc pivoting around the point of interest reduces forward motion blur.

When the tower inspection is complete, power plant 11 is turned on at maximum efficiency in power climb 22 to increase the altitude of airframe 10 quickly, ready for next linear right of way glide 24.

The third type of mission in power line inspection is checking the wires. Phase conductors are checked for broken strands or corrosion; deteriorating splices, spacers, or dampers; and missing marker balls. Shield wires are checked for lightning damage. If a shield wire is 1.5 cm in diameter and a lightning strike melts a third of the wire, then for reliable detection the wire sample distance should be less than ¼ cm. For the example camera with 5 micron pixels and a 28 mm focal length lens, airframe 10 with camera 16 should be within 14 m of the shield wire. At that distance the angle of view is not large enough to image all the wires in the configuration of FIG. 2 in one flight, so a compromise is made to fly low at 19 m away as shown by angle of view 56. The airframe has to fly catenary arcs to maintain this field of view. Power plant 11 can be turned off on the downslope catenary glide 28 and turned back on during the catenary climb 30.

Photogrammetry for mapping and measuring areas of the earth's surface emphasizes vertical photographs taken from a uniform flying height. Vertical photographs (tilt<3 degrees) have the same scale at all parts of the image. A uniform flying height makes it easier to stitch adjacent photographs together into a mosaic. The mosaic is then orthorectified to produce a digital elevation model and orthophoto with accurate results for an entire area of the earth's surface.

Oblique photographs are more useful in corridor inspection because they use the available angle of view on the objects of most interest. The scale does change from large at nadir to small in the distance. For corridor inspection the goal is detailed images of the right of way and points of interest in the corridor. Since resampling blurs detail, it may be better to present the viewer with the original images and calculate distances as needed. If the camera interior and exterior orientation are known at the time of exposure, then the scale in different parts of the image can be calculated.

Safety regulations require unmanned aerial vehicles to be able to sense and avoid other aircraft and obstacles. This is difficult to do with current sensor technology, so a human observer with radio control over the UAV acts to sense and avoid problems. For corridor inspection, a useful configuration is two UAVs flying on port and starboard of the right of way with a general aviation plane flying above them carrying an observer to sense and avoid problems. The UAVs each image a quadrant of the towers and wires that is difficult to see from the ground. If the interior and exterior orientations are known at each camera exposure, then the images can be used as stereo pairs to measure ground elevations and wire clearances.

In the configuration of two UAVs with an observer trailing in a general aviation plane, an out-and-back flight is preferable to a one-way flight. The general aviation plane has to return to its home airport and it is much more convenient to launch and land the UAVs in one location. The relative tower elevations can be measured on the way out during the right-of-way 18, 24 and tower 20, 26 inspections. Then the wire inspection 28, 30, 32, 34, which is flown much closer, can be flown precisely and safely.

Most transmission lines have the same tower configuration along the entire line to keep the wire clearances uniform. However, for impedance balancing, they will likely have transposition towers at one third and two thirds of the line length. The flight path described above is typically loosened up at transposition towers.

The above example is for a transmission line, but other overhead lines such as distribution, telephone, cable TV, and electric railway lines can be inspected with this efficient flight path.

Other utilities in corridors such as oil, gas, and water pipelines can be inspected with a similar flight path. The right of way is inspected for encroachment, signs of leaks (dead vegetation, discoloration, Airborne Laser Methane Assessment), sunken backfill, erosion, and evidence of heavy traffic. The pumping or compressor stations and valves are inspected for leaks, corrosion, and deterioration in much more detail.

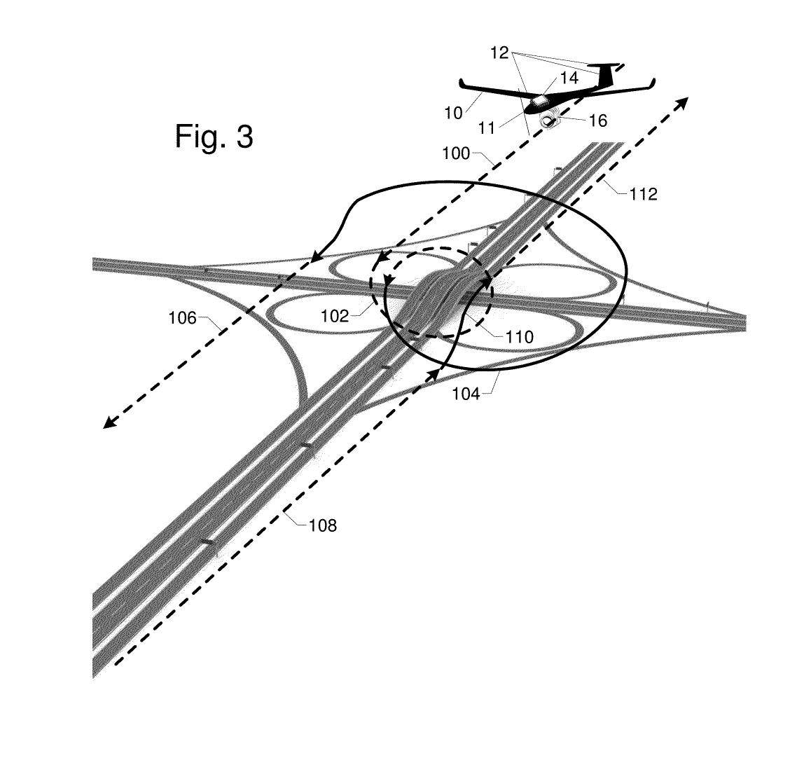

FIG. 3 is a perspective view of an efficient flight path for inspection of a transportation corridor. Airframe 10 supports power plant 11, control surfaces 12, autopilot 14, and camera 16. It flies a linear glide 100 to inspect the right of way for a transportation corridor. At a point of interest, in this case a bridge, it enters spiral glide 102 to take more detailed images. After the point inspection it starts power climb 104 to gain altitude and inspect the wider right of way at the intersection. At the correct altitude and lateral position, it starts right of way inspection linear glide 106 again. On the return trip it does a detailed examination of the roadway surface, first with a linear glide 108, then a power climb 110, followed by another linear glide 112.

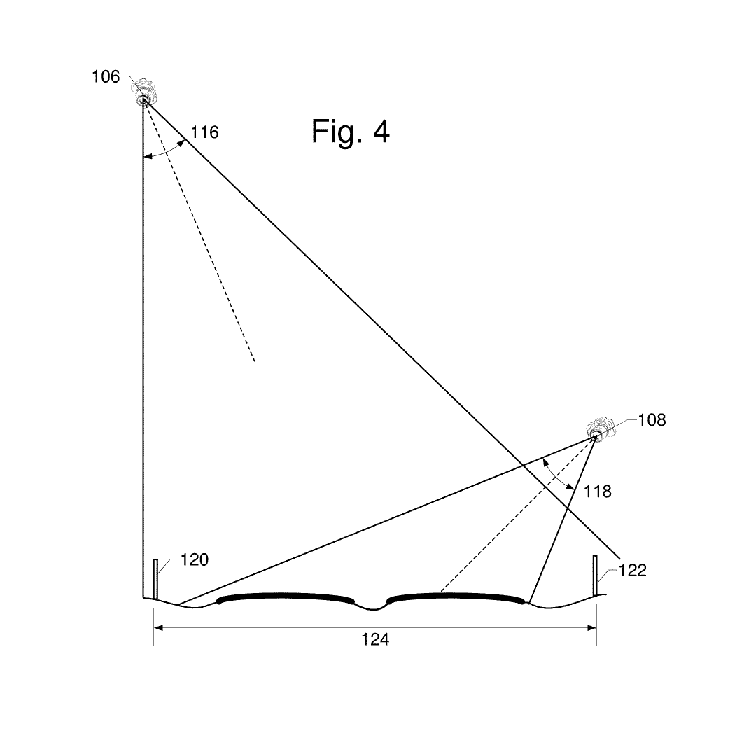

FIG. 4 is a cross-path section of the transportation corridor. During right of way inspection with linear glide 106, the angle of view 116 covers the entire right of way 124, including fences 120 and 122. For the more detailed roadway surface inspection linear glide 108, the angle of view 118 is focused on the roadway to get the best possible resolution.

Similar to the transmission line utility corridor inspection example above, the transportation corridor inspection illustrated in FIGS. 3 and 4 has three mission profiles. The right of way inspection with linear glide 106 has an angle of view 116 covering the entire right of way 124 with a goal of checking for encroachment, gaps in fences 120 and 122, and drainage issues. A GSD of 5 cm would be sufficient which would allow a height above ground of 280 m for our sample camera. The minimum height above ground for linear glide 106 shown in FIG. 2 is about 65 m, so with a glide slope of 20:1, linear glide 106 can be over 4 km long.

The detailed point inspection of a bridge with spiral glide 102 needs to capture the bridge in the angle of view so it can be flown lower and closer with a better GSD. The right of way is larger at an interchange, so power climb 104 flies a larger circle inspecting the right of way while climbing. At the appropriate altitude and lateral offset, airframe 10 starts the next linear glide 106.

A detailed roadway inspection with linear glide 108 and power climb 110 is flown much lower and closer with a field of view just encompassing the roadway to get a GSD of about ½ cm. Power climb 110 can be done between taking inspection photographs to maintain the benefit of low-vibration images.

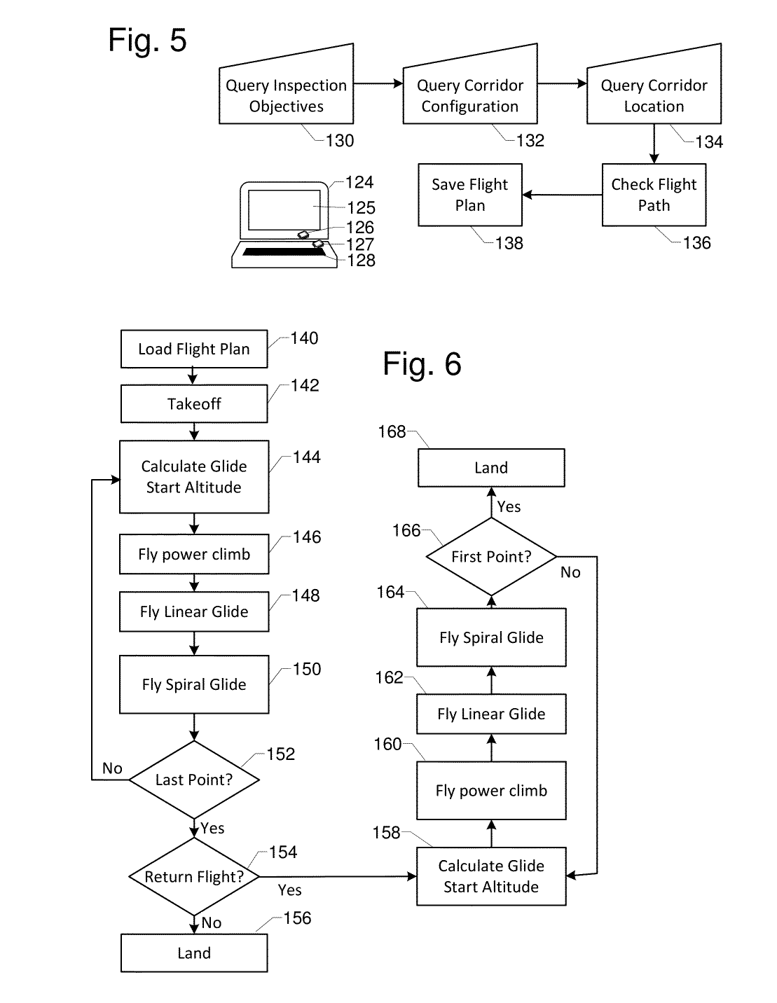

FIG. 5 is a flowchart representing flight planning prior to flight for an efficient corridor inspection. A computer 124 well known from the prior art includes a display 125, memory 126, processor 127, and input device 128. The flight plan is created on computer 124 and communicated to autopilot 14. First the system queries the operator on the inspection objectives 130. Then it queries for the corridor configuration 132 and location 134, either from operator input or from other data sources. With these inputs it checks the flight path 136 against regulatory, airframe, and camera constraints. Finally it saves the flight plan 138.

The inspection objectives 130 include the minimum field of view, maximum sample distance, and photo overlap for each mission profile. For the transmission line example illustrated in FIGS. 1 and 2, the right of way inspection is done with an angle of view 52 encompassing the entire right of way as well as the towers, with a minimum ground sample distance of ˜5 cm. The picture end overlap along the path is set to 10-20% to allow matching and mosaicking of adjacent images. The tower inspection is done with angle of view 54 encompassing the top of the tower with a tower sample distance of ½ cm. For a point of interest the operator can specify how many pictures around the point are required, e.g. 4 for principal compass points, 8 to include intermediate directions, 16, etc. The detailed inspection of the wires is done with angle of view 56 just encompassing all the wires with a wire sample distance of ¼ cm and ˜10% overlap. For detailed inspection between the points of interest, the operator specifies whether the flight path should match catenary arcs 28, 30, 32, 34; the terrain elevation for pipelines; or the roadbed/railbed 108, 110, 112 for transportation corridors.

The corridor configuration 132 includes the width of the right of way as a minimum. The operator may specify the flight path lateral offsets from the right of way centerline, both for asymmetric corridors, as well as for those situations where adjacent landowners may not agree to overflights for their property. The vertical elements in the right of way, e.g. towers 40, 42, 44; fences 120 and 122; bridges, signs, signals, pump houses, etc. have a big impact on the field of view and flight height above ground. For the transmission line example of FIGS. 1 and 2, the tower height, width, phase conductor spacing and geometry, and shield wire location and geometry define the field of view.

A very flexible approach is to provide a small computer aided design (CAD) interface to allow the operator to manipulate the corridor geometry and the angles of view for different missions to produce figures much like FIGS. 2 and 4. Specifically, the operator chooses a starting geometry for the corridor (e.g. tower profiles for different voltages; above/underground pipelines in shared trenches; highway, divided road, multilane road, single lane road, or track for transportation corridors). Then the interface allows the operator to adjust locations and size of on-screen representations of corridor elements to match the actual corridor geometry. Finally the operator adjusts the location and rotation of the angle of view 52, 54, 56, 116, or 118 to match the mission objective. The interface provides interactive feedback showing the sample distances, so the operator can make an informed choice when it is difficult to provide the desired field of view at the desired sample distance for the given camera, sensor, and lens.

The corridor location is defined by a set of waypoints (latitude, longitude, and altitude) for both the corridor centerline and the points of interest. If readily available, these may be entered by the operator. Easier for the operator is to ask for starting and ending points and then to trace the corridor on maps or satellite images. For example, in satellite imagery with ˜0.5-1 m resolution (e.g. Google and Bing), power transmission towers can be clearly identified, and depending on the light and contrast with the background, the phase conductors may be visible. While mapping the corridor location it is helpful to define a number of accessible planned and emergency landing sites.

After the mission objectives 130, corridor configuration 132, and location 134 are known the flight path has to be checked 136 against regulatory, airframe, and camera constraints. UAV operation is limited within a certain radius of airports (e.g. 3 miles in US), over military installations, or in other restricted airspace. Given the waypoints for the corridor location 134 and the flight height above ground from the corridor configuration 132, the flight path can be checked against government maps published for pilots. If problems are detected, the system can allow the operator to split the inspection into multiple segments, or suggest they ask an exemption for the flight.

The airframe will have a minimum flight speed of about 20% more than the stall speed, a maximum climb rate, specific glide slope, and fuel or battery capacity. The camera will have a maximum framing rate, a limit on picture storage, and a limit on battery life. The flight paths have to be checked against each of these limits with some reasonable estimates of headwinds to avoid problems in the field. If satellite imagery is available, then a simulated flight over the terrain (e.g. Google Earth) makes a quick check for errors or slipups in altitude or location.

After the flight path check 136, the flight plan is saved 138 for current and future inspections of the corridor. They are communicated to autopilot 14 to fly the efficient flight path, as described with reference to FIG. 6 below. The flight parameters include

Right of Way Inspection: Both port and starboard flight paths, including lateral offsets from corridor centerline, maximum height above ground for desired sample distance, minimum height above ground for desired field of view, camera declination from horizontal at both maximum and minimum heights, and image overlaps.

Point Inspection: Object location and height above ground relative to corridor centerline waypoint, maximum distance from object for desired sample distance, minimum object distance for desired field of view, camera declination from horizontal for maximum and minimum distances, and number of images spaced at angles around object.

Detailed Inspection: Camera offset lateral and vertical to get field of view; follow catenary (overhead electrical lines), terrain (pipelines), or road/railbed (transport); and image overlaps.

Corridor: Waypoint latitude, longitude, and altitude for the corridor and each point of interest, including planned and emergency landing sites and transposition towers.

FIG. 6 is a flowchart for autopilot 14 to fly an efficient corridor inspection flight path. First the flight parameters from the flight plan produced by the steps described in FIG. 5 is loaded 140, then the airframe takes off 142 and begins the loop of alternate climbs and glides. In that loop, autopilot 14 first calculates the glide start altitude 144 to determine the height of the power climb 146. Then it turns on power plant 11 for power climb 146, turning power plant 11 off at the required altitude, and beginning to fly linear glide 148. If there is a point of interest that needs more detailed inspection, then the end of the linear glide may be followed by a spiral glide 150. This loop of alternate climbs and glides continues until the last point 152 is reached. If a more detailed inspection is required on the return flight 154, then it repeats the climb-glide loop for the more detailed inspection. First it calculates glide start altitude 158, then it flies the power climb 160, flies the linear glide 162, optionally flies the spiral glide 164, and repeats until it reaches the first point 166, after which it lands 168.

To calculate glide start altitude 144, in this example for linear glide 24, autopilot 14 determines the distance and altitude of the next point of interest, for example tower 44. Given the minimum height above ground for the right of way inspection at the end of linear glide 18; the airframe glide ratio; the airframe penetrating glide speed; and the current head or tailwinds, it is straightforward to calculate the speed over ground and thus the altitude required at the start of linear glide 18 to get to tower 44 with power plant 11 off. If this is less than the maximum height above ground for the desired sample distance, then power climb 146 proceeds directly to this altitude. If it is more than the maximum, then the autopilot plans for an intermediate power climb before the point of interest.

To fly power climb 146, autopilot 14 turns on power plant 11 and adjusts control surfaces 12 for maximum climb to the altitude calculated in step 144 and the lateral position defined by the flight plan from FIG. 5. To avoid vibration blur, it is desirable to take photographs when power plant 11 is off, but some power climbs such as 30, 34, 104, and 110 may involve taking photographs to meet the inspection objectives without duplicating sections of the flight path.

To fly linear glide 148, autopilot 14 turns off power plant 11 and adjusts control surfaces 12 to get a glide speed that allows camera 16 to meet the image overlap requirements at its framing rate. If it comes close to the minimum height above ground for the desired field of view, then it plans for another power climb by going directly to calculate glide start altitude 144.

If there is an object of interest at the end of linear glide 148, then autopilot 14 adjusts control surfaces 12 to spiral glide 150 around the point of interest. Using the waypoint location, the object height above ground, the minimum distance for desired field of view, and the maximum distance for the desired sample distance at the point, airframe 10 spirals down and typically inward, taking photographs at the orientations specified in the flight plan.

If this is not the last waypoint 152, then the loop starts again with calculate glide start altitude 144. Otherwise, if there is no return flight 154, airframe 10 lands 156.

If there is a return flight, either with a different mission profile or because one UAV is flown out and back, then the climb, glide loop begins again (158, 160, 162, 164, 166). If the return mission is a more detailed inspection for a smaller field of view, then more precise flying is required in following the catenary arcs for overhead lines (28, 30, 32, 34), the terrain for pipelines, and the road/railbed for transportation corridors (108, 110, 112).

This section illustrated details of specific embodiments, but persons skilled in the art can readily make modifications and changes that are still within the scope. For example, the figures have illustrated a fixed wing UAV, but a rotary wing with a shallow descent path could also use this energy efficient flight path. The embodiments described have focused on inspection with a camera, but other inspection sensors such as UV cameras, IR cameras, LiDAR, RADAR, audible and ultrasound noise, or RF noise could also be used.

I claim:

1. An aerial inspection system for a corridor comprising:
an unmanned aerial vehicle,
a power plant that can be stopped and restarted in flight mounted on said vehicle to propel said vehicle,
an inspection sensor mounted on said vehicle to inspect said corridor,
glide means for movement of said vehicle with said power plant off,
power climb means for increasing altitude of said vehicle with said power plant on.

2. The aerial inspection system of claim 1, wherein glide means includes linear movement along said corridor.

3. The aerial inspection system of claim 1, wherein glide means includes spiral movement around objects of interest.

4. The aerial inspection system of claim 1, wherein said unmanned aerial vehicle uses a fixed wing airframe.

5. The aerial inspection system of claim 1, wherein said inspection sensor is a camera.

6. The aerial inspection system of claim 1, further comprising an autopilot mounted on said vehicle to direct said vehicle to fly said glide means and said power climb means.

7. The aerial inspection system of claim 6, wherein said autopilot calculates a glide start altitude prior to said power climb means.

8. The aerial inspection system of claim 6, further comprising flight planning means to create and communicate a flight plan for said autopilot.

9. The aerial inspection system of claim 1, wherein a plurality of unmanned aerial vehicles are flown at once to provide plural vantage points in said inspection.

10. A method for efficiently flying a segment of a flight plan during aerial inspection of a corridor comprising:
providing an unmanned aerial vehicle,
providing a power plant that can be turned on and off during flight mounted on said vehicle,
providing an inspection sensor mounted on said vehicle,
inspecting said corridor with said inspection sensor,
providing an autopilot mounted on said vehicle,
calculating glide start altitude on said autopilot,
climbing under direction of said autopilot to said altitude with said vehicle with said power plant on,
gliding said vehicle under direction of said autopilot with said power plant off.

11. The method of claim 10 further comprising spiral gliding said vehicle around a point of interest in said corridor with said power plant off.

12. The method of claim 10 wherein said unmanned aerial vehicle uses a fixed wing airframe.

13. The method of claim 10 wherein said inspection sensor is a camera.

14. The method of claim 10 wherein said inspecting, said calculating, said climbing, and said gliding are repeated for a plurality of flight segments in said flight plan.

15. The method of claim 14 further comprising
providing a flight planning computer that can communicate with said autopilot,
planning said plurality of flight segments to produce said flight plan,
communicating said flight plan to said autopilot.
